(19) United States
(12) Patent Application Publication
(10) Pub. No.: US 2006/0288108 A1
(43) Pub. Date: Dec. 21, 2006

(54) Video distribution system having a call control and video distribution coordination server

(75) Inventors: Shigeki Mukaiyam, Minato-ku (JP); Hiroshi Kurihara, Minato-ku (JP)

Correspondence Address: SUGHRUE MION, PLLC, 2100 PENNSYLVANIA AVENUE, N.W., SUITE 800, WASHINGTON, DC, 20037, US

(73) Assignee: NEC CORPORATION

(21) Appl. No.: 11/452,292

(22) Filed: Jun. 14, 2006

(30) Foreign Application Priority Data
Jun. 15, 2005 (JP) 2005-174443

(51) Int. Cl. G06F 15/16; H04N 5/44

(52) U.S. Cl. 709/227; 715/719

(57) ABSTRACT

A video distribution system is provided that is capable of distributing the same advertisement both to an originating user terminal and to a destination user terminal. Upon receipt of http request, WWW server transmits a call processing and video distribution request to a coordination server. At this time, the telephone numbers of the originating user terminal and the destination user terminal, and video to be distributed are specified by the call processing and video distribution request. Upon receipt of the call processing and video distribution request, coordination server performs originating call control and sets up a video distribution using a call processing protocol such as SIP. This results in setting up a telephone conversation between the originating user terminal and the destination user terminal, and setting video distribution to and receipt by destination user terminal. Coordination server then transmits an originating-side video distribution request to the video distribution server. Upon receipt of the originating-side video distribution request, the video distribution server performs video distribution to the originating user terminal.

### BACKGROUND OF THE INVENTION

1. Field of the Invention

The present invention relates to video distribution systems, and more particularly to systems for distributing videos to terminals.

2. Description of the Related Art

Heretofore, systems of this kind include a system for displaying an advertisement to a telephone caller to realize a no-charge call (see, for example, JP2002-125075A, hereinafter referred to as Patent document 1). In this system, an advertisement server in a data center distributes advertisement information to PCs (personal computers) for display, connected therewith via the Internet.

Also, in this system, when advertisement information is distributed, the CTI (Computer Telephony Integration) server, in the data center connects its telephone set to the called telephone, and the WWW (World Wide Web) server in the data center instructs a charging server in the telephone company to make the connection free of charge.

On the other hand, there is a technique in a videoconference system that enables a user to conduct a telephone conversation while viewing pictorial data (e.g., drawings), by using the Internet (see, for example, JP2002-140277A, hereinafter referred to as Patent document 2). In this system, a collaboration server establishes a session between two user terminals.

However, the aforementioned prior art video distribution systems suffer from the following problems. With the system described in Patent document 1, advertisement information is transmitted to an originating subscriber alone, and only the originating subscriber can view the advertisement. With the system described in Patent document 2, users of two user terminals, between which a session is established by the collaboration server, perform a videoconference while viewing or correcting drawings and the like, prepared by one of the two users. Thus, although conducting a telephone conversation while viewing pictorial data is possible, it is impossible for both user terminals to view advertisements.

### SUMMRAY OF THE INVENTION

It is an object to provide a video distribution system that is capable of distributing the same advertisement both to an originating user terminal and to a destination user terminal, thereby enhancing the advertising effect.

It is another object to provide a call control and video distribution coordination server that is used in the video distribution system.

According to one aspect of the invention, there is provided a video distribution system comprising:

a plurality of user terminals having at least a voice communication unit;

a video distribution server for distributing videos to said plurality of user terminals; and

a call control-video distribution coordination server for, when one of said user terminals originates a call, establishing connections between an originating user terminal and the video distribution server, between an destination user terminal and the video distribution server, and between the originating user terminal and the destination user terminal.

According to another aspect of the invention, there is provided a call control and video distribution coordination server including a control means for, when one of user terminals originates a call, establishing connections between an originating user terminal and a video distribution server, between a destination user terminal and the video distribution server, and between the originating user terminal and the destination user terminal.

The present invention thus makes it possible for a user to conduct a telephone conversation while receiving videos. Further, according to the present invention, the use of videos as advertisements allows services such as a no-charge telephone, discount of telephone charges, to be realized. Furthermore, in the present invention, the display of advertisements both on the originating user terminal and on the destination user terminal renders the contents of the advertisements common topics among the users, thus achieving an enhanced advertising effect.

The above and other objects, features and advantages of the present invention will become apparent from the following description with reference to the accompanying drawings which illustrate examples of the present invention.

### BRIEF DESCRIPTION OF THE DRAWINGS

FIG. 1 is a block diagram of a video distribution system according to an embodiment of the present invention;

FIG. 2 is a block diagram of a call control and video distribution coordination server;

FIG. 3 is a sequence chart illustrating a first example of operation of the video distribution system according to the embodiment shown in FIG. 1;

FIG. 4 is a sequence chart illustrating a second example of operation of the video distribution system according to the embodiment shown in FIG. 1; and

FIG. 5 is a sequence chart illustrating a third example of operation of the video distribution system according to the embodiment shown in FIG. 1;

### DETAILED DESCRIPTION OF THE PREFERRED EMBODIMENT

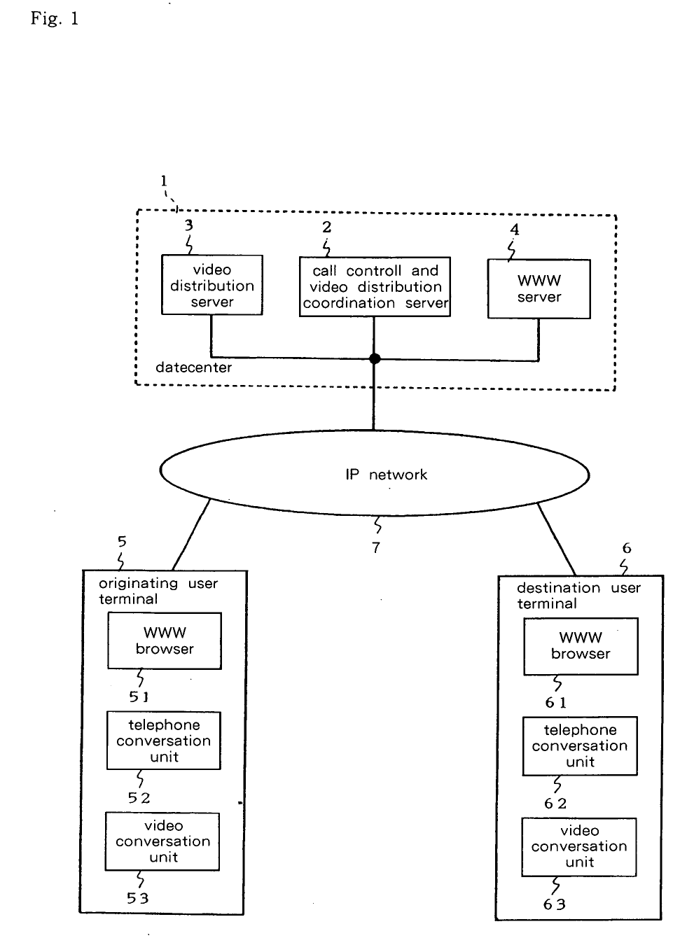

Referring now to FIG. 1, there is shown a video distribution system according to an embodiment of the present invention that comprises data center 1, originating user terminal 5, and destination user terminal 6 that are connected to each other via IP (Internet Protocol) network 7. Here, IP network 7 is a network that is capable of both a telephone conversation and video distribution.

Data center 1 includes call control and video distribution coordination server (hereinafter referred to as coordination server) 2, video distribution server 3, and WWW server 4. Originating user terminal 5 includes WWW browser 51, telephone conversation unit 52, and video reception unit 53. Similarly, destination user terminal 6 includes WWW browser 61, telephone conversation unit 62, and video reception unit 63.

Video distribution server 3 holds video contents, and is capable of distributing videos to a plurality of users at one time. WWW server 4 offers a video selection screen to WWW browser 51 of originating user terminal 5 and to WWW browser 61 of destination user terminal 6. A field through which a user can enter a telephone number of the party the user intends to call, and a video selection means are also provided on the video selection screen.

Coordination server 2 has a function to receive information from WWW server 4 and establish a session between video distribution server 3, originating user terminal 5 and destination user terminal 6 and a session between originating user terminal 5 and destination user terminal 6 using a protocol such as SIP (Session Initiation Protocol). Moreover, coordination server 2 has a function to check the capability of the terminals when establishing the session, and can establish only a telephone conversation session when the party terminal on the other end has no video reception capability.

A videophone, PC, kiosk terminal etc., may be used as originating user terminal 5, and a videophone, PC, and a telephone terminal etc., may be used as destination user terminal 6. In addition to terminals having a video reception capability such as a videophone, PC etc., terminals such as a telephone terminal that has no video reception capability but has only a telephone conversation capability may be used.

A user may specify the telephone number of the party the user intends to call to select a video using WWW browsers 51, 61 of originating user terminal 5 and destination user terminal 6. At this time, a user may not select a video, in which case a video is selected by coordination server 2. Call Origination by the user is carried out using an http (hyper text transfer protocol) request etc. Upon receipt of the http request, WWW server 4 transmits information indicative of the receipt to coordination server 2.

Upon receipt of the information, coordination server 2 establishes a session between originating user terminal 5 and video distribution server 3 to distribute videos. Thereafter, coordination server 2 establishes a session between destination user terminal 6 and video distribution server 3. Finally, coordination server 2 establishes a session between originating user terminal 5 and destination user terminal 6.

In the video distribution system of the present embodiment, the user can thus conduct a telephone conversation while receiving videos. Further, in the video distribution system of the present embodiment, the use of videos as advertisements enables services such as no-charge telephone, discount of telephone charges, to be realized. Furthermore, in the video distribution system of the present embodiment, display of advertisements both on originating user terminal 5 and on destination user terminal 6 renders the contents of the advertisements common topics between the users, thus achieving an enhanced advertising effect.

Moreover, in the video distribution system of the present embodiment, a user's request is executed via http, and start of video distribution during a telephone conversation and selection of advertisements to be distributed, at the initiative of a user, are possible, thereby enabling high-accuracy distribution of advertisements to target users.

Additionally, in the video distribution system of the present embodiment, by distributing videos for payment, the same moving pictures can be distributed to two remotely located terminals. This makes it possible to concurrently receive videos that could have been conventionally viewed by only one user or at only one terminal and to conduct a telephone conversation between two terminals.

In the video distribution system of the present embodiment, since the distribution of videos to both the users of originating user terminal 5 and destination user terminal 6 is achieved, the effect of advertisement can be improved when videos are utilized as an advertising medium and the convenience of a video distribution service for users can be enhanced through the distribution of videos to two terminals

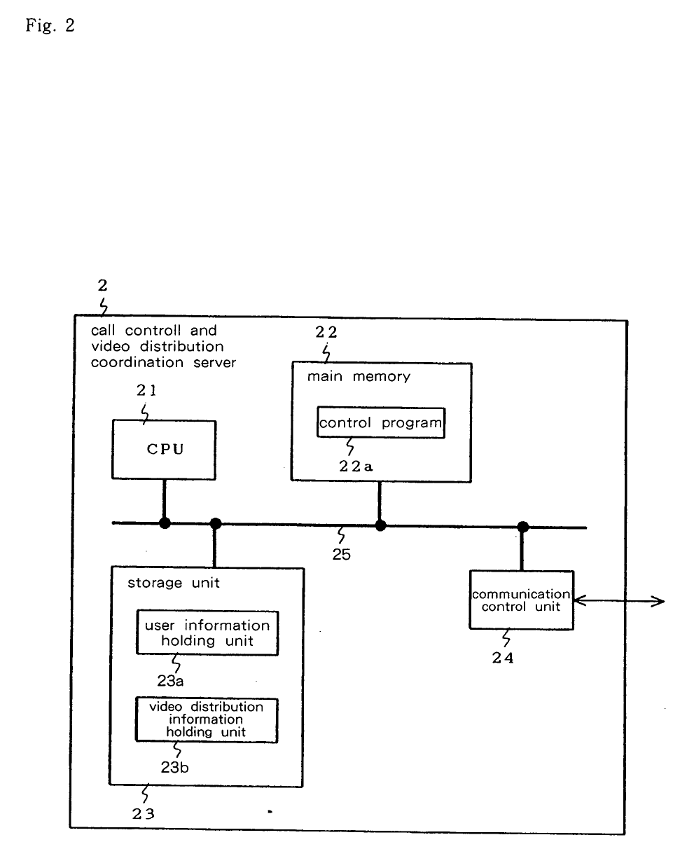

FIG. 2 is a block diagram of coordination server 2. As shown in FIG. 2, coordination server 2 comprises: CPU (Central Processing Unit) 21 for executing a variety of processing; main memory 22 for storing control program 22a executed by CPU 21; storage unit 23 that is used as a work area when CPU 21 executes control program 22a; and communication control unit 24 for controlling the communication with IP network 7. CPU 21, main memory 22, storage unit 23, and communication control unit 24, and internal bus 25 that connects CPU 21, main memory 22, storage unit 23, and communication control unit 24 to each other via internal bus 25.

Storage unit 23 includes: user information holding unit 23a for holding user information including communication information for communication control unit 24 to communicate with originating user terminal 5, destination user terminal 6, video distribution server 3, and WWW server 4; and video distribution information holding unit 23b for holding information of videos that are distributed from video distribution server 3 to originating user terminal 5 and destination user terminal 6.

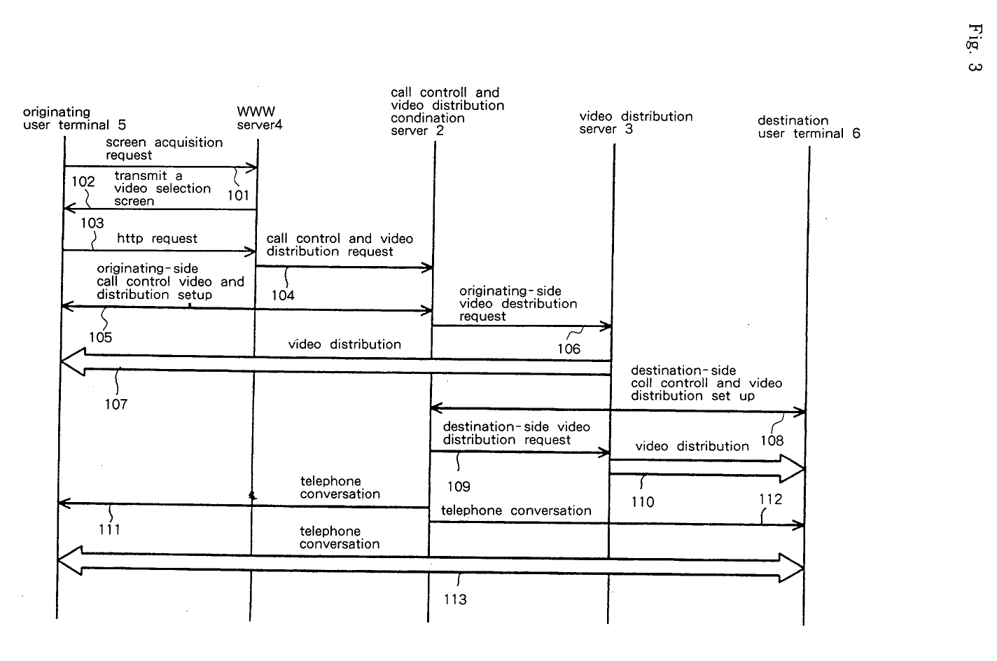

A first example of operation of the video distribution system of the present embodiment will now be described with reference to the sequence chart shown in FIG. 3. The operation of coordination server 2 in FIG. 3 is implemented through the execution of control program 22a by CPU 21.

At step 101, WWW browser 51 of originating user terminal 5 transmits a screen acquisition request to WWW 4. In response, at step 102, WWW server 4 transmits a video selection screen to WWW browser 51. The video selection screen includes a field through which a user can enter a telephone number of the party the user intends to call and a video selection means (for example, a list of videos to be distributed).

The user of originating user terminal 5 originates a call by specifying the telephone number of destination user terminal 6 on the video selection screen displayed by WWW browser 51. As a result, at step 102, http request is transmitted from originating user terminal 5 to WWW server 4. At that time, the telephone number of destination user terminal 6 is specified by the http request. Instead of specifying the telephone number of destination user terminal 6, the telephone number of originating user terminal 5 may be specified.

When the telephone number of originating user terminal 5 is not specified by the http request, it is acquired from user information (information held by user information holding unit 23a) contained within WWW server 4 or coordination server 2.

Upon receipt of the http request, WWW server 4 at step 104 transmits a call processing and video distribution request to coordination server 2. At this time, the telephone numbers of originating user terminal 5 and of destination user terminal 6, and videos that are to be distributed are specified by the call processing and video distribution request.

Upon receipt of the call processing and video distribution request, coordination server 2 at step 105 performs an originating call control and sets up video distribution to originating user terminal 5 using a call processing protocol such as SIP. This results in setting up a telephone conversation between originating user terminal 5 and destination user terminal 6, and setting video distribution to and receipt by originating user terminal 5. Coordination server 2 then transmits an originating-side video distribution request to video distribution server 3 at step 106. Upon receipt of the originating-side video distribution request, video distribution server 3 performs video distribution to originating user terminal 5 at step 107.

Subsequently, at step 108, coordination server 2 performs an incoming call control and setting up video distribution to destination user terminal 6 using a call processing protocol such as SIP. This results in setting up a telephone conversation between originating user terminal 5 and destination user terminal 6, and setting video distribution to and receipt by destination user terminal 6. Thereafter, at step 109, coordination server 2 transmits a destination-side video distribution request to video distribution server 3. Upon receipt of the destination-side video distribution request, video distribution server 3 performs video distribution to destination user terminal 6 at step 110.

Finally, coordination server 2 transmits a telephone conversation start message to originating user terminal 5 and destination user terminal 6 at step 111 and 112, respectively. As a result, at step 113, a telephone conversation is commenced between originating user terminal 5 and destination user terminal 6.

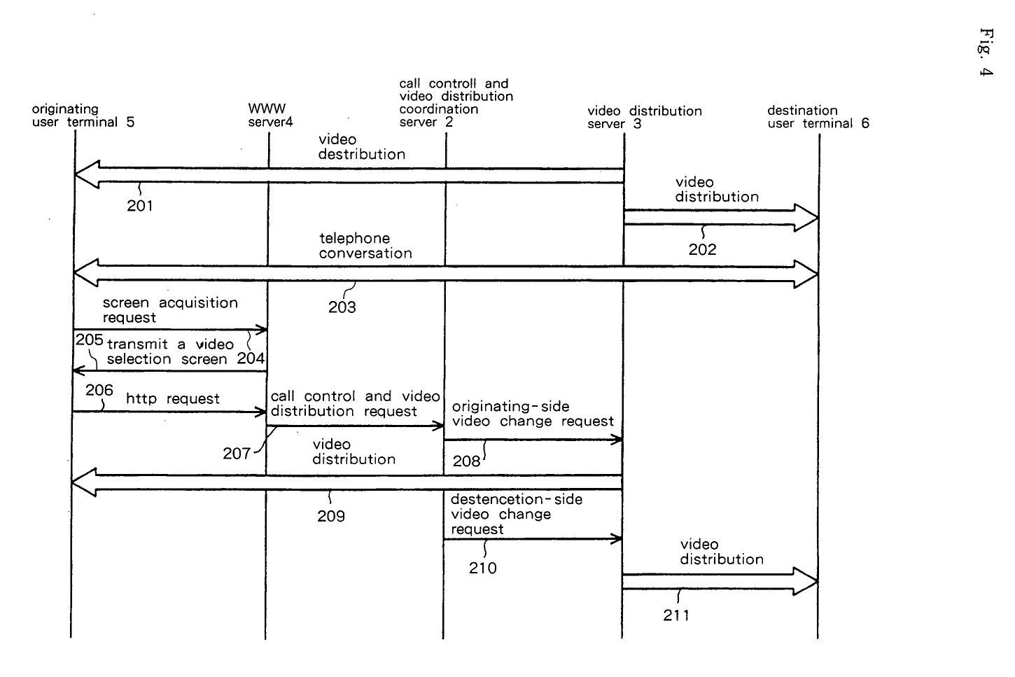

FIG. 4 is a sequence chart illustrating another operation of the video distribution system of the present embodiment. The operation of coordination server 2 in FIG. 4 is implemented through the execution of control program 22a by CPU 21.

With the procedures shown in FIG. 3 completed, video distributions to both originating user terminal 5 and destination user terminal 6 and a telephone conversation between originating user terminal 5 and destination user terminal 6 are carried out (step 201 to 203). During this situation, at step 204, originating user terminal 5 again transmits a screen acquisition request to WWW server 4.

Upon receipt of the screen acquisition request, WWW server 4 again transmits a screen indicating that videos are being received to originating user terminal 5 at step 205. In addition to the operations of temporary halt, fast forward, fast reverse and the like of videos that are being received, change of the video to another video is possible on the screen. When another video is selected, originating user terminal 5 transmits an http request to specify the selected video to WWW server 4 at step 206.

Upon receipt of the http request, WWW server 4 again transmits a video distribution request to coordination server 2 at step 207. If coordination server 2 again receives the video distribution request during video distribution, then it transmits an originating-side video change request to video distribution server 3 at step 208. Upon receipt of the originating-side video change request, video distribution server 3 halts the video distribution to originating user terminal 5, and distributes the specified video to originating user terminal 5 at step 209.

Subsequently, at step 210, coordination server 2 transmits a destination-side video change request. Upon receipt of the destination-side video change request, video distribution server 3 halts the video that is being distributed to destination user terminal 6, and distributes the specified video to destination user terminal 6 at step 211.

In the present embodiment, by utilizing originating user terminal 5 in which WWW browser 51 is available during reception of videos, in addition to the operations of temporary halt, fast forward, fast reverse and the like of videos that are being received, interactive operations such as change of videos are made possible by WWW browser 51 during reception of videos.

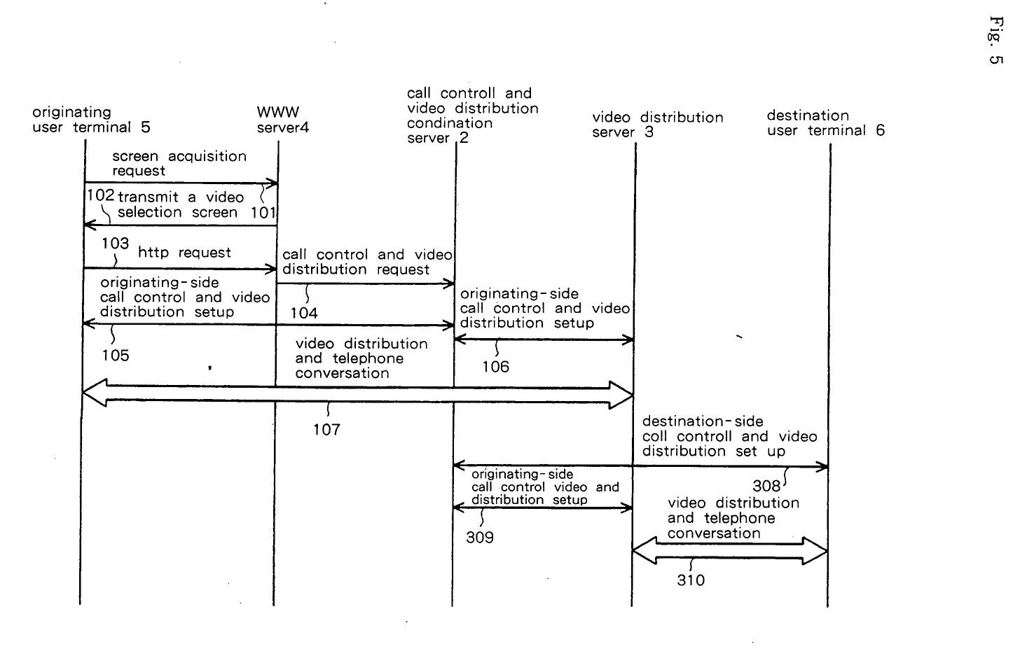

FIG. 5 is a sequence chart illustrating yet another operation of the video distribution system of the present embodiment. The operation of coordination server 2 in FIG. 5 is implemented through the execution of control program 22a by CPU 21.

In the present example, upon receipt of a call control and video distribution request, coordination server 2 establishes a bilateral voice and video session between originating user terminal 5 and video distribution server 3 (see step 301-307). Then, coordination server 2 establishes a bilateral voice and video session between destination user terminal 6 and video distribution server 3 (step 308-310).

The present example differs from the previous examples in these operations. The use of these two sessions allows distribution of videos from video distribution server 3 to originating user terminal 5 and to destination user terminal 6, and a telephone conversation between originating user terminal 5 and destination user terminal 6.

In order to allow the telephone conversation, video distribution server 3 has the capability to transfer voice information from originating user terminal 5 to destination user terminal 6 and vice versa between the two sessions. Transmission of images from the user terminals to video distribution server 3 is not effected. In the present example, the user terminal cannot handle two sessions: a telephone conversation and a video reception at one time. However, the present example is applicable to a videophone terminal and the like that is capable of a bilateral voice and video communication.

While a preferred embodiment of the present invention has been described using specific terms, such description is for illustrative purposes only, and it is to be understood that changes and variations may be made without departing from the spirit or scope of the following claims.

What is claimed is:

1. A video distribution system comprising:
a plurality of user terminals having at least a voice communication unit;
a video distribution server for distributing videos to said plurality of user terminals; and
a call control and video distribution coordination server for, when one of said user terminals originates a call, establishing connections between an originating user terminal and said video distribution server, between a destination user terminal and said video distribution server, and between said originating user terminal and said destination user terminal.

2. The system according to claim 1, wherein said call control and video distribution coordination server includes means for establishing a session between said originating user terminal and said video distribution server, a session between said destination user terminal and said video distribution server, and a telephone conversation session between said originating user terminal and said destination user terminal, using a call processing protocol.

3. The system according to claim 1, wherein said call control-video distribution coordination server includes means for establishing a bilateral voice and video session between said originating user terminal and said video distribution server, and a bilateral voice and video session between said destination user terminal and said video distribution server at the time of the originating.

4. The system according to claim 2 or 3, wherein said user terminals each further include WWW browser and a video reception unit.

5. The system according to claim 4, wherein said user terminals originate a call through http request, and said system further comprises a WWW server for, upon receipt of the http request, transmitting information indicative of the receipt of the request to said call control and video distribution coordination server.

6. The system according to claim 4, wherein said user terminals each includes means for performing specification of a called subscriber telephone number and selection of videos

7. The system according to claim 4, wherein said call control and video distribution coordination server further includes means for, when said user terminal does not select the video using the WWW browser, selecting said video for said user terminal.

8. The system according to claim 4, wherein said user terminal is a videophone, a personal computer, or a kiosk terminal.

9. The system according to claim 1, wherein said call control and video distribution coordination server further includes means for, in response to a request from said user terminal during distribution of videos, transmitting an originating-side video change request and a destination-side video change request to change videos being distributed to said originating user terminal and said destination user terminal.

10. The system according to claim 9, wherein said call control and video distribution coordination server further includes means for causing said video distribution server to perform any one of the operations of temporary halt, fast forward, fast reverse and the like of the video, and the change of said video to another video in accordance with the request from said user terminal through the transmission of said originating-side video change request and said destination-side video change request.

11. In a video distribution system comprising a plurality of user terminals having at least a voice communication unit, and a video distribution server for distributing videos to said user terminals, a call control and video distribution coordination server including a control means for, when one of said user terminals originates a call, establishing connections between an originating user terminal and said video distribution server, between a destination user terminal and said video distribution server, and between said originating user terminal and said destination user terminal.

12. The call control and video distribution coordination server according to claim 11, wherein said control means establishes a session between said originating user terminal and said video distribution server, a session between said destination user terminal and said video distribution server, and a telephone conversation session between said originating user terminal and said destination user terminal, using a call processing protocol.

13. The call control and video distribution coordination server according to claim 11, wherein said control means establishes a bilateral voice and video session between said originating user terminal and said video distribution server, and a bilateral voice and video session between said destination user terminal and said video distribution server at the time of the originating.

14. The call control and video distribution coordination server according to claim 11, wherein when said user terminal does not select the video using a WWW browser, said control means selects said video for said user terminal

15. The call control and video distribution coordination server according to claim 11, wherein said control means, in response to a request from said user terminal during distribution of videos, transmits an originating-side video change request and a destination-side video change request to change videos being distributed to said originating user terminal and said destination user terminal.

16. The call control and video distribution coordination server according to claim 15, wherein said control means causes said video distribution server to perform any one of the operations of temporary halt, fast forward, fast reverse and the like of said video, and the change of said video to another video in accordance with the request from said user terminal through the transmission of said originating-side video change request and said destination-side video change request.

17. A computer program for video distribution used in a system comprising a plurality of user terminals having at least a voice communication unit, and a video distribution server for distributing videos to said user terminals, said computer program causing a computer in a call control and video distribution coordination server to execute, when one of said user terminals originates a call, establish connections between an originating user terminal and said video distribution server, between a destination user terminal and said video distribution server, and between said originating user terminal and said destination user terminal.
